(19) United States
(12) Patent Application Publication
(10) Pub. No.: US 2025/0127189 A1
(43) Pub. Date: Apr. 24, 2025

(54) Cottonseed Protein Texturization and Methods and Uses Thereof

(71) Applicant: Louis Dreyfus Company Plant Proteins LLC, Livermore, CA (US)

(72) Inventors: Shalini Mishra, Livermore, CA (US); Koraljka Rade Kukic, Livermore, CA (US); Manoj Kumar, Livermore, CA (US); William Alexander, Piedmont, CA (US)

(21) Appl. No.: 18/916,484

(22) Filed: Oct. 15, 2024

Related U.S. Application Data
(60) Provisional application No. 63/545,109, filed on Oct. 20, 2023.

(51) Int. Cl. A23J 3/14; A23J 3/22; A23J 3/26

(52) U.S. Cl. CPC A23J 3/14; A23J 3/227; A23J 3/26

(57) ABSTRACT

Embodiments included herein provide for texturized vegetable products and methods for texturizing a cottonseed-based protein. Some embodiments utilize cottonseed protein alone or in combination with other plant-based proteins. Detailed examples of cottonseed protein texturization are also provided.

### CROSS-REFERENCE TO RELATED APPLICATIONS

This application claims the benefit of U.S. Provisional Patent Application No. 63/545, 109, filed Oct. 20, 2023, which application is incorporated herein by reference in its entirety.

### FIELD OF THE INVENTION

The present invention relates to protein texturization, more specifically, methods to texturize cottonseed-based proteins, which can be used to produce a meat alternative.

### BACKGROUND

Oil seeds, such as cottonseed, are an emerging source of proteins for culinary applications. Recent trends toward the use of plant proteins to replace animal-derived protein has created a significant demand for the production of plant protein products with unique and desirable qualities, particularly for use in foods meant to replace animal-based products. Seed-derived proteins have become a coveted source for producing nutritionally enhanced products and meat and dairy substitutes with preferred textural appeal and varied functionalities. Therefore, protein isolates from seeds that are both economical and have desirable physical properties for use in plant-based foods and products is needed.

Common sources of plant proteins include soy, wheat, and pea protein. Soybean protein is typically texturized by extruding the protein. In WO 2013/047644, the soybean protein was treated with a reducing sugar and an organic acid. After extrusion, the meat alternative is texturally similar to meat and lacks an aftertaste. Similarly, U.S. Pat. No. 4,888,198 uses extrusion to texturize soybean protein, but the product is compressed and dehydrated to be easy to handle, store and ship. The resulting products are resistant to fragmentation or flaking and rehydrate rapidly.

For pea, methods have included extrusion, such as disclosed in US 2008/0226811. However, pea protein extrusion needs additional components (e.g., starch, other protein) to be effective. In contrast, 2021/119614 texturizes pea protein (and protein from other legumes) by using transglutaminase to crosslink proteins within the sample. Crosslinking the proteins produces a gelatinous loaf, block, or lump that can be shaped or sized.

However, due to celiac diseases and gluten sensitivity, product developers are looking to exclude gluten from formulations. Similarly, in certain markets soy acceptance is decreasing among consumers due to various reasons, including negative perception of GMO, deforestation issues and presence of phytoestrogens. Therefore, finding new protein ingredients with texture forming ability, that are well accepted by the consumer, has been a long-standing task of scientists and the food industry.

### SUMMARY OF THE INVENTION

This summary is meant to provide some examples and is not intended to limit the scope of the invention in any way. For example, any feature included in an example of this summary is not required by the claims, unless the claims explicitly recite the features. Various features and steps as described elsewhere in this disclosure may be included in the examples summarized here, and the features and steps described here and elsewhere can be combined in a variety of ways.

One embodiment provides a method for texturizing cottonseed protein, including incubating an aqueous composition including a cottonseed-based protein product at a temperature of 90-175° C. for a time of approximately 3 seconds to approximately 30 minutes, where the combination of temperature and time induce protein texturization within the cottonseed-based protein product and cooling the aqueous composition or allowing the aqueous composition to cool to a temperature of 10-89° C.

Further embodiments may incubate the aqueous composition at a temperature between 100° C. and 175° C. and/or between 110° C. and 140° C. Additionally the period of time may be 3 seconds to 5 minutes and/or approximately 2.5 minutes. Cooling the aqueous composition or allowing the aqueous composition to cool comprises cooling the aqueous composition or allowing the aqueous composition to cool to a temperature of 10-70° C. and/or 20-50° C. Some embodiments may refrigerate the aqueous composition to a temperature of −80-10° C. The cottonseed-based protein product may have a protein concentration of at least 50%, at least 65%, at least 80%, and/or at least 90%, while the aqueous composition may be 10-80% protein, 15-60% protein, and/or 15-40% protein. Certain cottonseed-based protein products may be cottonseed protein isolate alone, while some cottonseed-based protein products may be cottonseed protein isolate in combination with one or more of pea protein isolate, soybean protein isolate, wheat protein isolate, canola seed protein isolate, sunflower seed protein isolate, mustard seed protein isolate, peanut protein isolate, sesame protein isolate, safflower protein isolate, flaxseed protein isolate, tree nut protein isolate, palm kernel protein isolate, and corn protein isolate. Further methods can include applying a shear force to the aqueous composition, where the shear force can be selected from extruding, stirring, and high shear mixing. When using extrusion, the shear force may be applied to cottonseed-based protein products by passing through an extrusion die and/or by an extruder drive screw.

An additional embodiment includes a texturized vegetable product (TVP) including a texturized cottonseed-based protein.

In further embodiments, the texturized cottonseed-based protein may further be porous and/or fibrous. Additionally, the cottonseed-based protein extract may include at least 50% protein, at least 65% protein, at least 80% protein, and/or at least 90% protein. Certain TVPs may include one or more of pea protein isolate, soybean protein isolate, wheat protein isolate, canola seed protein isolate, sunflower seed protein isolate, mustard seed protein isolate, peanut protein isolate, sesame protein isolate, safflower protein isolate, flaxseed protein isolate, tree nut protein isolate, palm kernel protein isolate, and corn protein isolate. The TVP can be a consumer and/or an industrial product. The TVP can also be a food product selected from a meat alternative, a breakfast cereal, a snack bar, a snack mix, a pasta, and a bread dough. In some food products, the TVP can further include one or more of a flavorant, a salt, a glutamate, a stabilizer, a buffer, a preservative, and a colorant. TVPs as described can be texturized via methods described above or via extrusion, protein spinning, electrospinning, or shear cell technology. Extrusion can include high moisture and/or low moisture extrusion. TVPs can also be texturized by cooking the cottonseed-based protein at one or more of a high-temperature and a high-pressure.

Other features and advantages of the present invention will become apparent from the following detailed description, taken in conjunction with the accompanying drawings which illustrate, by way of example, the principles of the invention.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates exemplary data showing a presence of an endothermic peak showing that cottonseed meal protein denatures upon heating above 93° C., in accordance with various embodiments of the invention.

FIGS. 2A-2C, FIGS. 3A-3C, FIGS. 4A-4B, and FIGS. 5A-5C provide images of texturized cottonseed meal protein under various conditions, in accordance with various embodiments of the invention.

FIGS. 6A-6B and FIGS. 7A-7B provide electron micrographs of texturized cottonseed meal protein isolates, in accordance with various embodiments of the invention.

FIGS. 8A-8B and FIGS. 9A-9B provide images of texturized cottonseed meal protein under various conditions, in accordance with various embodiments of the invention.

FIGS. 10A-10B provide images of texturized mixtures cottonseed meal protein and pea protein under various conditions, in accordance with various embodiments of the invention.

### DETAILED DESCRIPTION

Cottonseed is an underutilized byproduct of cotton production. While cottonseed has been used for its oil, the presence of gossypol has limited its use as a food product. Gossypol is a phenolic aldehyde that can be toxic to humans, while being safe up to certain levels for cattle and some other ruminants. Recent advances have led to new varieties of cotton with reduced gossypol, thus opening the possibility for its use as a meat alternative. Embodiments included herein provide for methods for texturizing cottonseed protein, for uses including meat alternatives. Some embodiments utilize cottonseed protein alone or in combination with another plant-based protein. Detailed examples of cottonseed protein texturization are also provided.

Before the present processes, compositions and uses are described, it is to be understood that this invention is not limited to the particular methods or compositions described, which may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described. All publications mentioned herein are incorporated herein by reference to disclose and describe the methods and/or materials in connection with which the publications are cited. It is understood that the present disclosure supersedes any disclosure of an incorporated publication to the extent there is a contradiction.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It must be noted that as used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Definitions

The term “about” particularly in reference to a given quantity, is meant to encompass deviations of plus or minus ten percent.

The term “texturization” refers to a process of using mechanical and structuring agents and other manipulations to modify the structure of a food component for better functionalities, such as creating a three-dimensional structure that is capable of substituting for another product. For example, protein texturization can be used as a meat analog. Texturization can result in fibers, shreds, chunks, bits, slices, films, and/or granules, depending on the source. Protein texturization generally involves a denaturation step followed by re-organization and orientation of the partially or totally unfolded proteins.

The term “food product” refers to any edible composition and/or any composition for consumption by an animal, including humans and non-human animals, such as (but not limited to) birds, fish, reptiles, amphibians, and non-human mammals. Food products can include natural and artificial components. Certain food products can also include compounds given a generally recognized as safe (GRAS) classification.

The term “protein aggregation” refers to the phenomenon in which disordered and/or mis-folded proteins accumulate and clump together. Aggregation can be stabilized by non-covalent interactions between peptide chains and/or the formation of disulfide bridges between cysteine residues.

The term “non-covalent interactions” refers to molecular interactions that do not form covalent bonds. “Non-covalent interactions” can include ionic interactions, van der Waals interactions, polar interactions, and/or any other non-covalent bod.

The term “protein isolate” refers to a portion that is purified or enriched for protein content. A protein isolate is generally considered to be at least about 85% protein. As such, a protein isolate can be at least 80% protein, at least 85% protein, at least 90% protein, at least 95% protein, or at least 99% protein. In certain instances, a protein isolate is at least 88% protein.

The term “meal” refers to a crushed seed or grain. “Meal” can be defatted (i.e., after oil extraction) or possess all native components (e.g., protein, carbohydrates, oils, etc.).

The term “flour” refers to a refined meal, such as by grinding to a fine particle size. Such particle sizes can be of various sizes, such as less than 0.5 mm or finer. Flour may be sieved or filtered to remove seed components, such as a seed coat, bran, aleurone, embryo, or other seed component.

### Texturizing Cottonseed-Based Proteins

Many embodiments herein provide processes for the texturization of cottonseed proteins, also referred to as a texturized vegetable product, or TVP. TVPs can have various physical properties that make it advantageous for certain uses, including as a consumer product or industrial product. Consumer products can include food products and/or other domestic or consumer-grade products; while industrial products can include spacers, sponges, gaskets, and/or other industrial need. Food products can include meat alternatives, gluten-free alternatives (depending on protein source), animal feed (including wet and/or dry pet foods), and/or other edible items. Many cottonseed-based proteins can be used as meat alternatives. Cottonseed can be used for as a gluten-free alternative, such as breakfast cereals, snack bars, snack mixes, pasta, bread doughs (including sandwich bread, bread rolls, pizza crust, and/or other products).

As noted previously, texturized cottonseed protein can have various properties, such as flexibility, elasticity, firmness, resiliency, shear force, porosity, hydration level, fibrosity, and/or other properties. Certain textures may be more desirable for certain uses. For example, a more elastic network of protein fibers may be desirable for use as a meat alternative (where elastic is considered resilient, springy, and/or describes the ability of the texturized product to rebound to an initial state after an applied force is removed). The differences in texture or other physical characteristics can depend on the proteins present in the starting specimen, amount of such proteins, and/or characteristics of the method used. Such characteristics may include factors such as pH, time, temperature, ionic concentration, and/or any other characteristic.

Certain embodiments are made solely of cottonseed protein product. The protein product can include meal, flour, an extract, a concentrate, an isolate, or other cottonseed-based item with a protein content, and combinations thereof.

A cotton-based protein product can originate from whole plant or a subset of plant tissue, such as seeds, leaves, cotyledons, any other part of a plant, and combinations thereof. In many embodiments, the cotton-based protein product originates from cottonseeds (i.e., cottonseed-based protein product). In certain instances, the cottonseed-based protein product can be a protein isolate, where the protein isolate has a protein concentration of at least 80% protein, at least 85% protein, at least 90% protein, at least 95% protein, or at least 99% protein. In certain instances, a protein isolate has a protein concentration of at least 85% protein. The protein concentration can be lower by using a flour and/or meal and/or concentrate alone or in combination with a protein isolate. Flour, meal, concentrate or mixtures including a protein isolate with flour and/or meal and/or concentrate may have a lower protein concentration, for example at least 30% protein, at least 35% protein, at least 40% protein, at least 45% protein, at least 50% protein, up to at least 80% protein or more. When using cottonseed, various embodiments may use a cottonseed-based protein product that has a reduced gossypol concentration. Gossypol reduction can be from a cotton variety with reduced gossypol—e.g., a variety that has been bred and/or genetically modified to limit gossypol production or to breakdown gossypol. In other instances, gossypol may be removed from cottonseed meal and/or cottonseed flour that are known or may be developed in the art via means that effectively filter out gossypol or selectively enrich for protein.

Additional embodiments include cottonseed protein and at least one other protein source selected from one or more of pea, soybean, wheat, and canola seed (rapeseed), sunflower seed, mustard seed, peanut, sesame, safflower, flax seed, tree nuts, palm kernel, corn, and combinations thereof.

In some embodiments, an aqueous composition comprising a cottonseed-based protein product is incubated. In some instances, the cottonseed-based protein is a composition or suspension including a cottonseed-based protein product (e.g., as described above). Such a composition or suspension can include an organic solvent and/or an aqueous solvent. A resulting composition—e.g., an aqueous composition—may have a protein concentration of approximately 10-80% protein. In some instances, an aqueous composition has a protein concentration of 15-60% protein. In certain instances, an aqueous composition has a protein concentration of 15-40% protein. In various embodiments, the protein concentration is approximately 20% protein (e.g., ±5%). The percentage of protein in an aqueous composition may affect the resultant texture, such as elasticity, porosity, etc.

Various embodiments texturize the cottonseed-based protein by incubating the protein at a temperature for a period of time, where the time and temperature are sufficient to induce protein aggregation and/or denaturation. Methods to heat the cottonseed-based protein product include any valid method to heat the protein product, including microwave oven, conventional oven, convection oven, steam oven, direct heat, indirect heat, fire, pressure, stove, conductive heat, radiative heat, and combinations thereof. The temperature should be high enough to disrupt some protein structure and/or cause an amount of protein aggregation. In certain embodiments, the temperature is at least 90° C., at least 100° C., or at least 110° C. In some embodiments, the temperature is between 90° C. and 175° C. The temperature may further be between 100° C. and 175° C. The temperature may further be between 110° C. and 140° C. Various embodiments maintain a constant temperature, while other embodiments may maintain a temperature within a specified range (e.g., 110° C.±5° C.). Certain embodiments may utilize a dynamic temperature that is based on real-time assessment of aggregation and/or follows a preset temperature pattern (e.g., start at a first temperature and ramp to a second temperature over the period of time).

The period of time should be long enough that protein aggregates and produces the desired properties, such as flexibility, elasticity, firmness, resiliency, shear force, porosity, hydration level, fibrosity, texture, etc. The period of time can be a preset or predetermined amount of time. Such amount of time can be from approximately 30 seconds to approximately 30 minutes. In various embodiments, the amount of time may be 1-5 minutes, such as approximately 1 minute, approximately 1.5 minutes, approximately 2 minutes, approximately 2.5 minutes, approximately 3 minutes, approximately 3.5 minutes, approximately 4 minutes, approximately 4.5 minutes, approximately 5 minutes, etc. In certain instances, the amount of time is 1-5 minutes, such as approximately 1 minute, approximately 1.5 minutes, approximately 2 minutes, approximately 2.5 minutes, approximately 3 minutes, etc. In certain cases, the amount of time is approximately 2.5 minutes. In certain embodiments, the amount of time may be dynamically determined based on real-time assessment of aggregation.

Additional embodiments apply a shear force to the cottonseed-based protein product, including aqueous compositions comprising a cottonseed-based protein product. Such shear forces can include one or more of stirring, high shear mixing, extruding, kneading, and combinations thereof. In certain embodiments, the shear force can be applied during incubation. In an extrusion-based process, a shear force can be applied as a cottonseed-based protein product passes through an extrusion die. In addition to, or instead of, a shear force applied by an extrusion die, a shear force can be applied by an extruder drive screw. Parameters regarding the shear force include speed, distance, revolutions, force, extruder die hole size, pressure, and/or any other relevant parameter. Such shear force can be applied during incubation and/or after incubation, such as to assist in the texturization of the cottonseed-based protein.

After the incubation, certain embodiments cool or chill the cottonseed-based protein product to a lower temperature. Such cooling can be active (e.g., use of refrigeration) or passive (e.g., allowing a product to cool by removing a heat source). Such a temperature can be any temperature below the incubation temperature (e.g., below 90° C.). In certain embodiments, the temperature reduction is sufficient to prevent further aggregation or alteration to texturization. Such temperatures can be below 90° C., below 85° C., below 80° C., below 75° C., below 70° C., below 65° C., below 60° C., below 55° C., or below 50° C. Various embodiments cool the cottonseed-based protein product to a temperature at or below 50° C. In some instances, the cooling involves allowing the cottonseed-based protein to cool to a storage temperature. Storage temperatures can be any temperature sufficient to preserve the texturized cottonseed-based protein for a period of time. Such temperatures may be an ambient temperature, “room temperature,” or other temperature that does not require refrigeration. Such temperatures can be approximately 30° C., approximately 25° C., approximately 20° C., approximately 15° C., or less. Some cooling brings the texturized cottonseed-based protein to a refrigerated temperature, such as a temperature of a household or consumer refrigerator and/or freezer. Refrigerators are generally considered to be approximately 4° C. (+6° C./−3° C.), while freezers are generally considered to be approximately −5° C., −10° C., −15° C., −20° C., or less, depending on a particular make, model, or setting. Cryogenic temperatures can also be achieved (e.g., approximately −70° C., −80° C., −90° C., −100° C., or lower). Keeping the foregoing information in mind, certain embodiments cool or allow a cottonseed-based protein product to cool to a temperature of 20-89° C. In certain instances, the cottonseed-based protein product is allowed to cool to a temperature of 10-70° C. In some cases, the cottonseed-based protein product is allowed to cool to a temperature of 20-50° C. In various embodiments, the cottonseed-based protein product is refrigerated to a temperature of −80° C. to 10° C.

### Texturized Vegetable Products

As noted previously, certain cottonseed-based proteins can be used to form Texturized Vegetable Products (TVPs), which can include consumer and/or industrial products. TVPs can have desirable characteristics, including (but not limited to) texture and/or aesthetics. TVPs of many embodiments can be texturized from a cottonseed-based protein product as described above. In certain instances, TVPs can be texturized by one or more of extrusion, protein spinning, electrospinning, or shear cell technology. In embodiments that use extrusion, extrusion may be high moisture extrusion. In other extrusion-based embodiments, extrusion may be low moisture extrusion. In some embodiments, the TVP is texturized by cooking a cottonseed-based protein product at one or more of a high-temperature and a high-pressure. In various instances, texturization forms an elastic network. In certain embodiments, the elastic network is fibrous. In additional instances, the elastic network is porous.

The TVPs can originate from cottonseed protein alone. Certain embodiments utilize a cottonseed protein isolate. Additional embodiments use cottonseed protein isolate mixed with a flour, meal, and/or isolate from pea, soybean, wheat, canola seed (rapeseed), sunflower seed, mustard seed, peanut, sesame, safflower, flax seed, tree nuts, palm kernel, corn, and combinations thereof.

TVPs can be made into meat alternatives. Such meat alternatives may be formed into shapes. Such shapes can include shapes commonly associated with meat products, such as a drumstick, a rib, a steak, a nugget, a whole foul, a breast, and/or any other look alike. Other embodiments may form the meat alternative into festive or novel shapes, such as sports balls, stars, fireworks, or any other desired shape.

Additionally, various meat alternatives of some embodiments may be formed with two different textures. Non-homogeneity between textures may provide more desirable characteristics, such as mimicking skin or providing a better chewing experience. Different textures may be joined via an edible or food-grade adhesive and/or by using enzymatic methods, such as transglutaminase.

TVPs can further include components that contribute to taste, aesthetics, and/or stability. Such additives can include flavorants, extracts, salts, glutamates, stabilizers, buffers, preservatives, colorants, and/or any other common component that can be added to increase consumer appeal.

As noted above, TVP-based food products can include (but are not limited to) breakfast cereals, snack bars, snack mixes, pasta, bread doughs (including sandwich bread, bread rolls, pizza crust, and/or other products). As cottonseed does not include gluten, such food products can further be gluten-free food products. Such products can include additional ingredients for flavor, flavor enhancement, color, texture, stability, etc.

TVPs can also be implemented for industrial purposes as replacements of petroleum-based products, where a TVP has similar physical properties. Such industrial products may include (but are not limited to) rubbers and/or other flexible materials. Industrial products can include spacers, gaskets, filters, sponges etc., where an elastic network may be used, including when an elastic network is porous and/or fibrous. Certain embodiments can increase rigidity by creating a composite material form a TVP. Such composites can be created by combining a TVP with additives, such as resins, adhesives, cements, and/or other material to create a composite material.

For purposes of completeness, various aspects of the present disclosure are set out in the following numbered clauses. Without limiting the foregoing description, certain non-limiting aspects of the disclosure numbered 1-36 are provided below. As will be apparent to those of skill in the art upon reading this disclosure, each of the individually numbered aspects may be used or combined with any of the preceding or following individually numbered aspects. This is intended to provide support for all such combinations of aspects and is not limited to combinations of aspects explicitly provided below:
Aspect 1. A method for texturizing cottonseed protein, comprising:
   incubating an aqueous composition comprising a cottonseed-based protein product at a temperature of 90-175° C. for a time of 3 seconds to 30 minutes, wherein the combination of temperature and time induce protein texturization within the cottonseed-based protein product; and
   cooling the aqueous composition or allowing the aqueous composition to cool to a temperature of 10-89° C.
Aspect 2. The method of Aspect 1, wherein incubating an aqueous composition comprises heating the aqueous composition to between 100° C. and 175° C.
Aspect 3. The method of any of Aspects 1-2, wherein incubating the aqueous composition comprises heating the aqueous composition to between 110° C. and 140° C.
Aspect 4. The method of any of Aspects 1-3, wherein the time of said incubation is 3 seconds to 5 minutes.
Aspect 5. The method of any of Aspects 1-4, wherein the time of said incubation is approximately 2.5 minutes.
Aspect 6. The method of any of Aspects 1-5, wherein cooling the aqueous composition or allowing the aqueous composition to cool comprises cooling the aqueous composition or allowing the aqueous composition to cool to a temperature of 10-70° C.
Aspect 7. The method of any of Aspects 1-6, wherein cooling the aqueous composition or allowing the aqueous composition to cool comprises cooling the aqueous composition or allowing the aqueous composition to cool to a temperature of 20-50° C.
Aspect 8. The method of any of Aspects 1-7, further comprising refrigerating the aqueous composition to a temperature of −80-10° C.
Aspect 9. The method of any of Aspects 1-8, wherein the cottonseed-based protein product has a protein concentration of at least 50%.
Aspect 10. The method of any of Aspects 1-9, wherein the cottonseed-based protein product has a protein concentration of at least 65%.
Aspect 11. The method of any of Aspects 1-10, wherein the cottonseed-based protein product has a protein concentration of at least 80%.
Aspect 12. The method of any of Aspects 1-11, wherein the cottonseed-based protein product has a protein concentration of at least 90%.
Aspect 13. The method of any of Aspects 1-12, wherein the aqueous composition comprises 15-60% protein.
Aspect 14. The method of any of Aspects 1-13, wherein the aqueous composition comprises 15-40% protein.
Aspect 15. The method of any of Aspects 1-14, wherein the aqueous composition further comprises one or more of the group consisting of: pea protein, soybean protein, wheat protein, canola seed protein, sunflower seed protein, mustard seed protein, peanut protein, sesame protein, safflower protein, flaxseed protein, tree nut protein, palm kernel protein, and corn protein.
Aspect 16. The method of any one of Aspects 1-14, wherein the aqueous composition further comprises pea protein.
Aspect 17. The method of any of Aspects 1-16, further comprising applying a shear force to the aqueous composition during said incubation.
Aspect 18. The method of Aspect 17, wherein the shear force is selected from extruding, stirring, kneading, and high shear mixing.
Aspect 19. The method of Aspects 17 or 18, wherein the shear force is applied as the cottonseed-based protein passes through an extrusion die.
Aspect 20. The method of any of Aspects 17-19, wherein the shear force is applied by an extruder drive screw.
Aspect 21. A texturized vegetable product produced by the method of any one of Aspects 1-20.
Aspect 22. A texturized vegetable product (TVP), comprising a texturized cottonseed-based protein.
Aspect 23. The TVP of Aspect 22, wherein the texturized cottonseed-based protein is porous.
Aspect 24. The TVP of Aspect 22 or 23, wherein the texturized cottonseed-based protein is fibrous.
Aspect 25. The TVP of Aspect 22-24, wherein the cottonseed-based protein comprises at least 50% protein.
Aspect 26. The TVP of Aspect 22-25, wherein the cottonseed-based protein comprises at least 65% protein.
Aspect 27. The TVP of any of Aspects 22-26, wherein the cottonseed-based protein comprises at least 80% protein.
Aspect 28. The TVP of any of Aspects 22-27, wherein the cottonseed-based protein comprises at least 90% protein.
Aspect 29. The TVP of any of Aspects 25-28, further comprising one or more of the group consisting of: pea protein, soybean protein, wheat protein, canola seed protein, sunflower seed protein, mustard seed protein, peanut protein, sesame protein, safflower protein, flaxseed protein, tree nut protein, palm kernel protein, and corn protein.
Aspect 30. The TVP of any of Aspects 22-29, wherein the TVP is selected from a consumer product or an industrial product.
Aspect 31. The TVP of any of Aspects 22-30, wherein the TVP is a food product selected from a meat alternative, a breakfast cereal, a snack bar, a snack mix, a pasta, and a bread dough.
Aspect 32. The TVP of Aspect 31, wherein the TVP further comprises one or more of a flavorant, a salt, a glutamate, a stabilizer, a buffer, a preservative, and a colorant.
Aspect 33. The TVP of any of Aspects 22-32, wherein the cottonseed-based protein is texturized by extrusion, protein spinning, electrospinning, or shear cell technology.
Aspect 34. The TVP of any of Aspects 22-32, wherein the cottonseed-based protein is texturized by high moisture extrusion.
Aspect 35. The TVP of any of Aspects 22-32, wherein the cottonseed-based protein is texturized by low moisture extrusion.
Aspect 36. The TVP of any of Aspects 22-32, wherein the cottonseed-based protein is texturized by cooking the cottonseed-based protein at one or more of a high-temperature and a high-pressure.

### EXEMPLARY EMBODIMENTS

Although the following embodiments provide details on certain embodiments of the inventions, it should be understood that these are only exemplary in nature and are not intended to limit the scope of the invention.

### Example 1: Protein Isolation From Cottonseed

Defatted cottonseed meal (CSM) are milled at a temperature range of 0 to 30°° C. using a lab-scale multifunction grain grinder (HC-700 2500W, LeJieyin, China) and are further sieved using a Rotap Sieve Shaker (RX-29, W.S. Tyler, Mentor, OH, USA) to generate a cottonseed meal flour (CSMF) fraction (particle size <0.5 mm and protein purity 50%) for the making of cottonseed meal protein isolate (CSMPI). The CSMPI is extracted from CSMF by an alkaline extraction followed by isoelectric precipitation at pH 4.0. For the purification, the CSMF is dispersed in reverse osmosis (RO) water (1:4 to 1:10, w/v) and the solution pH is adjusted to pH 9-11 using base (including but not limited to KOH, Ca(OH)₂, (NH₄)OH and NaOH). The solution is further stirred for 10-60 min at a temperature (22-75° C.) and then is centrifuged for 10 min at 7000 g at room temperature using a Sorval LYNX 4000 centrifuge (Thermo Fisher Scientific, Waltham, MA, USA). The supernatant is then decanted and subsequently the soluble supernatant's pH is adjusted to ˜4.0 (pl of protein is 4.0) using acid (including but not limited to HCl, Citric Acid, H₃PO₄, and Acetic Acid). Isoelectric precipitation temperature is in the range of 25° C. to 75° C., and duration from about 15 min to about 60 min. The resultant mixture is further centrifuged [7000 g for 10 min at room temperature] to obtain protein rich pellets, which are washed and are then diluted with 2×(by weight) of RO water. The pH of the resultant solution is adjusted to 7 by adding 1M NaOH and is freeze dried using Labconco Free Zone 6 freeze-dryer. This process produces CSMPI with 85-95% purity.

### Example 2: Cottonseed Meal Protein Denaturation

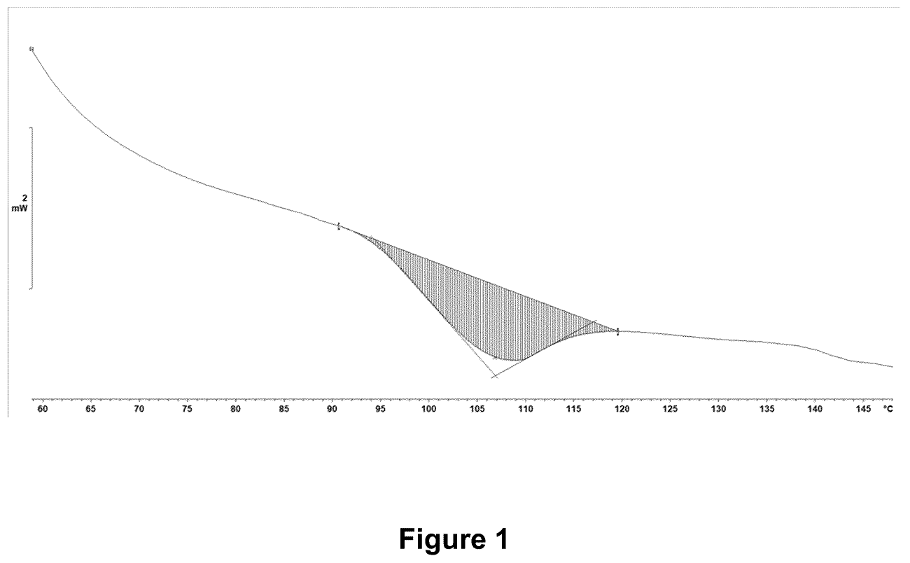

The denaturation temperature of CSMP was determined by differential scanning calorimetry (DSC). The presence of endothermic peak (FIG. 1) showed the CSMP contains native protein that denatured upon heating above 93° C.

### Example 3: Cottonseed Protein Solubility

Dispersion containing 4% protein (based on the amount of protein in the wet powder determined preliminary by AOAC 992.15) was prepared by dispersing CSMP powder in RO water and stirring for 2 hours at room temperature. Subsequently, pH of the dispersion was measured (FiveEasy™ Plus FP20 pH/mV Meter, Metler Toledo US). If pH of a dispersion was away from pH 7 (>0.2), it was adjusted to pH 7 with NaOH or HCl (1M and 0.1M) under constant stirring. Dispersion was further centrifuged at 15000 g using Sorvall Lynx 4000 centrifuge (Thermo Scientific, US) for 15 min at room temperature. The supernatant was carefully recovered, and nitrogen content was measured by a combustion method using a LECO FP828 (Leco, US), according to the Association of Official Agricultural Chemists (AOAC) method 992.15—crude protein in meat and meat products. To estimate protein content in the supernatant, nitrogen to protein conversion factor of 6.25 was used. Soluble protein was calculated by dividing the protein content of the supernatant by the total protein in the initial sample.

Protein Solubility (%)=(Protein content in supernatant/total protein content)*100

### Example 4: Cottonseed Meal Protein Texturization

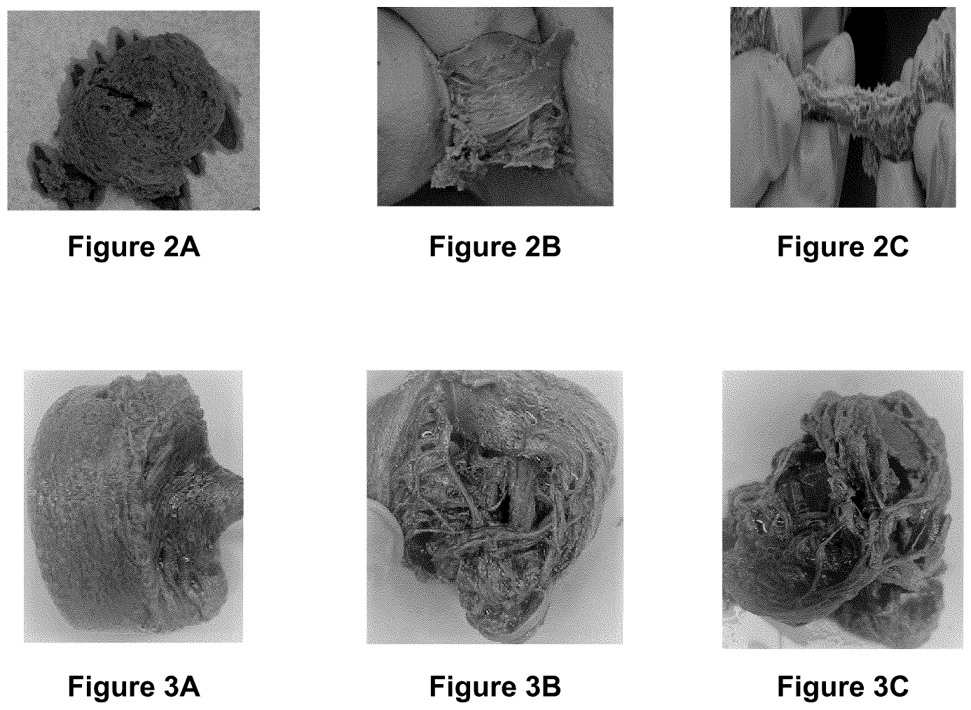

An aqueous paste of CSMP at a concentration of about 18% protein was heated in an RVA 4800 under stirring to the temperature of 140° C. It was held at 140° C. for 2.5 minutes and then cooled down to below 50° C. Subsequently, texture of samples was evaluated visually (FIGS. 2A-2C).

FIG. 2A illustrates an image of an 18% protein CSMP sample taken out of RVA cell upon heating to 140° C. and cooling to below 50° C.; FIGS. 2B & 2C provide images of the sample after tearing and stretching.

### Example 5: Cottonseed Meal Protein Texturization

An aqueous paste of CSMP at a concentration of about 20% protein was heated in the RVA 4800 under stirring to the temperature of 140° C., held at 140° C. for 2.5 minutes, and then cooled down to below 50° C. Subsequently, texture of samples was evaluated visually (FIGS. 3A-3C).

FIG. 3A provides an image of a 20% protein CSMP sample taken out of the RVA cell upon heating to 140° C. and cooling to below 50° C.; FIGS. 3B & 3C provide images of the sample after tearing and stretching.

### Example 6: Cottonseed Meal Protein Texturization

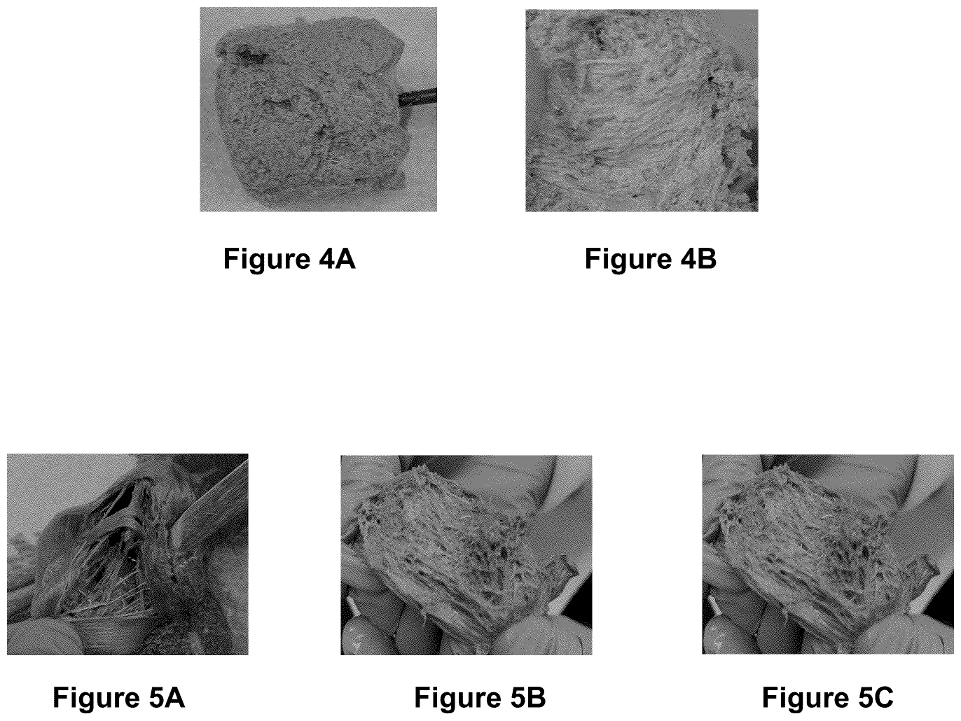

An aqueous paste of CSMP at a concentration of about 22% protein was heated in the RVA 4800 under stirring to the temperature of 110° C. and held at this temperature for 2.5 minutes. Subsequently, samples were cooled down to a temperature below 50° C. and their texture was evaluated visually (FIGS. 4A-4B).

FIG. 4A illustrates the 22% protein CSMP sample taken out of the RVA cell upon heating to 110° C. and cooling to below 50° C., while FIG. 4B provides an image of the sample after tearing.

### Example 7: Cottonseed Meal Protein Texturization

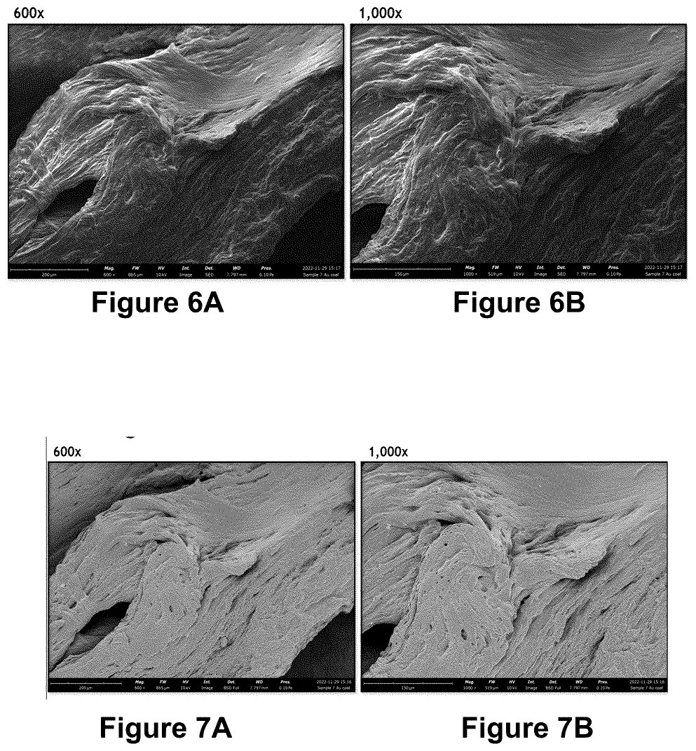

An aqueous paste of CSMP at a concentration of about 22% protein was heated in the RVA 4800 under stirring to the temperature of 140° C., it was held at 140° C. for 2.5 minutes and then cooled down to below 5020 C. Subsequently, texture of samples was evaluated visually (FIGS. 5A-5C) and by Phenom G6 ProX (FIGS. 6A-6B & FIGS. 7A & 7B).

FIG. 5A provides an image of the 22% protein CSMPI sample taken out of RVA cell upon heating to 140° C. and cooling to below 50° C.; FIGS. 5B & 5C provide images of the sample after tearing and stretching.

FIGS. 6A-6B provide secondary electron detector (SED) Imaging of texturized CSMPI (22% protein) sample taken out of RVA cell upon heating to 140° C. and cooling to below 50° C.

FIGS. 7A-7B provide backscatter electron detector (BED) Imaging of texturized CSMPI (22% protein) sample taken out of RVA cell upon heating to 140° C. and cooling to below 50° C.

### Example 8: Cottonseed Meal Protein Texturization

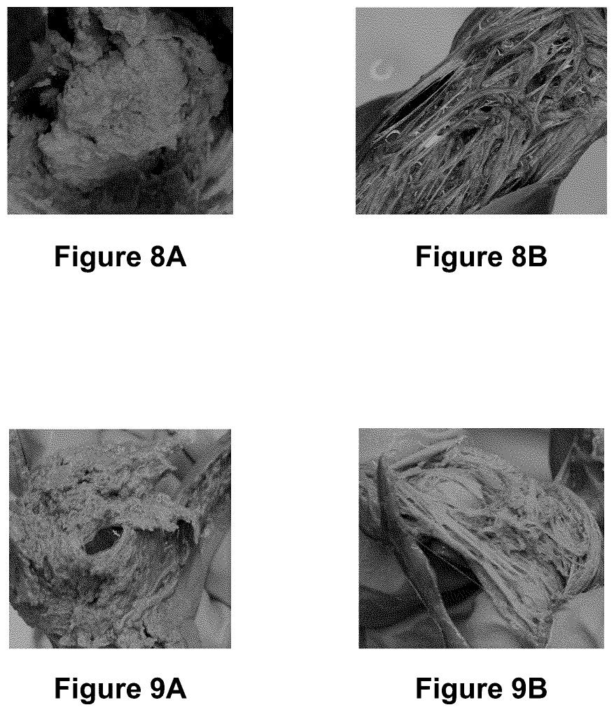

An aqueous paste of CSMP at a concentration of about 25% protein was heated in the RVA 4800 under stirring to a temperature of 140° C., held at 140° C. for 2.5 minutes and then cooled down to below 50° C. Subsequently, texture of samples was evaluated visually (FIGS. 8A-8B).

FIG. 8A provides an image of the 25% protein CSMP at room temperature; FIG. 8B provides an image of the fibrous and elastic texture of the 25% protein CSMP taken out of RVA cell upon heating to 140° C. and cooling to below 50° C.

Example 9: Cottonseed Meal Protein Texturization

An aqueous paste of CSMP at concentration of about 25% protein was heated in the RVA 4800 under stirring to the temperature of 110° C., it was held at 110° C. for 2.5 minutes and then cooled down to below 50° C. Subsequently, texture of samples was evaluated visually (FIGS. 9A-9B).

FIG. 9A provides an image of the 25% protein CSMP sample taken out of the RVA cell upon heating to 110° C. and cooling to below 50° C.; FIG. 9B provides an image of the sample after tearing and stretching.

### Example 10: Cottonseed Meal Protein Texturization

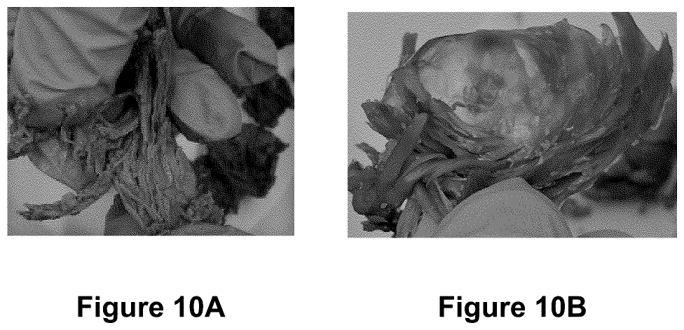

An aqueous paste containing 25% protein on wet basis, made by blending CSMPI and pea protein isolate (PPI) in 50:50 and 30:70 CSMPI: PPI ratio, were heated in the RVA 4800 under stirring to the temperature of 140° C., the samples were held at 140° C. for 2.5 minutes and then cooled down to below 50° C. Subsequently, texture of samples was evaluated visually (FIGS. 10A-10B).

FIG. 10A provides an images of a 25% protein blend of CSMPI & PPI (50:50 ratio) taken out of the RVA cell upon heating to 140° C. and cooling to below 50° C.; FIG. 10B provides an images of a 25% protein blend of CSMPI & PPI (30:70 ratio) taken out of the RVA cell upon heating to 140° C. and cooling to below 50° C.

### DOCTRINE OF EQUIVALENTS

Having described several embodiments, it will be recognized by those skilled in the art that various modifications, alternative constructions, and equivalents may be used without departing from the spirit or scope of the invention. Additionally, a number of well-known processes and elements have not been described in order to avoid unnecessarily obscuring the present invention. Accordingly, the above description should not be taken as limiting the scope of the invention.

Those skilled in the art will appreciate that the foregoing examples and descriptions of various preferred embodiments of the present invention are merely illustrative of the invention as a whole, and that variations in the components or steps of the present invention may be made within the spirit and scope of the invention. Accordingly, the present invention is not limited to the specific embodiments described herein, but, rather, is defined by the scope of the appended claims.

1. A method for texturizing cottonseed protein, comprising:
incubating an aqueous composition comprising a cottonseed-based protein product at a temperature of 90-175° C. for a time of 3 seconds to 30 minutes, wherein the combination of temperature and time induce protein texturization within the cottonseed-based protein product; and
cooling the aqueous composition or allowing the aqueous composition to cool to a temperature of 10-89° C.

2. The method of claim 1, wherein incubating an aqueous composition comprises heating the aqueous composition to between 100° C. and 175° C.

3. The method of claim 1, wherein incubating the aqueous composition comprises heating the aqueous composition to between 110° C. and 140° C.

4. The method of claim 1, wherein the time of said incubation is 3 seconds to 5 minutes.

5. The method of claim 4, wherein the time of said incubation is approximately 2.5 minutes.

6. The method of claim 1, wherein cooling the aqueous composition or allowing the aqueous composition to cool comprises cooling the aqueous composition or allowing the aqueous composition to cool to a temperature of 10-70° C.

7. The method of claim 6, wherein cooling the aqueous composition or allowing the aqueous composition to cool comprises cooling the aqueous composition or allowing the aqueous composition to cool to a temperature of 20-50° C.

8. The method of claim 1, further comprising refrigerating the aqueous composition to a temperature of −80-10° C.

9. The method of claim 1, wherein the cottonseed-based protein product has a protein concentration of at least 50%.

10. The method of claim 9, wherein the cottonseed-based protein product has a protein concentration of at least 65%.

11. The method of claim 10, wherein the cottonseed-based protein product has a protein concentration of at least 80%.

12. The method of claim 11, wherein the cottonseed-based protein product has a protein concentration of at least 90%.

13. The method of claim 1, wherein the aqueous composition comprises 15-60% protein.

14. The method of claim 13, wherein the aqueous composition comprises 15-40% protein.

15. The method of claim 1, wherein the aqueous composition further comprises one or more of the group consisting of: pea protein, soybean protein, wheat protein, canola seed protein, sunflower seed protein, mustard seed protein, peanut protein, sesame protein, safflower protein, flaxseed protein, tree nut protein, palm kernel protein, and corn protein.

16. The method of claim 15, wherein the aqueous composition further comprises pea protein.

17. The method of claim 1, further comprising applying a shear force to the aqueous composition during said incubation.

18. The method of claim 17, wherein the shear force is selected from extruding, stirring, kneading, and high shear mixing.

19. The method of claim 17, wherein the shear force is applied as the cottonseed-based protein passes through an extrusion die.

20. The method of claim 17, wherein the shear force is applied by an extruder drive screw.

21. A texturized vegetable product produced by the method of claim 1.

22. A texturized vegetable product (TVP), comprising a texturized cottonseed-based protein.

23. The TVP of claim 22, wherein the texturized cottonseed-based protein is porous.

24. The TVP of claim 22, wherein the texturized cottonseed-based protein is fibrous.

25. The TVP of claim 22, wherein the cottonseed-based protein comprises at least 50% protein.

26. The TVP of claim 25, wherein the cottonseed-based protein comprises at least 65% protein.

27. The TVP of claim 26, wherein the cottonseed-based protein comprises at least 80% protein.

28. The TVP of claim 27, wherein the cottonseed-based protein comprises at least 90% protein.

29. The TVP of claim 22, further comprising one or more of the group consisting of: pea protein, soybean protein, wheat protein, canola seed protein, sunflower seed protein, mustard seed protein, peanut protein, sesame protein, safflower protein, flaxseed protein, tree nut protein, palm kernel protein, and corn protein.

30. The TVP of claim 22, wherein the TVP is selected from a consumer product or an industrial product.

31. The TVP of claim 22, wherein the TVP is a food product selected from a meat alternative, a breakfast cereal, a snack bar, a snack mix, a pasta, and a bread dough.

32. The TVP of claim 31, wherein the TVP further comprises one or more of a flavorant, a salt, a glutamate, a stabilizer, a buffer, a preservative, and a colorant.

33. The TVP of claim 22, wherein the cottonseed-based protein is texturized by extrusion, protein spinning, electrospinning, or shear cell technology.

34. The TVP of claim 22, wherein the cottonseed-based protein is texturized by high moisture extrusion.

35. The TVP of claim 22, wherein the cottonseed-based protein is texturized by low moisture extrusion.

36. The TVP of claim 22, wherein the cottonseed-based protein is texturized by cooking the cottonseed-based protein at one or more of a high-temperature and a high-pressure.
